(19) United States
(12) Patent Application Publication
(10) Pub. No.: US 2008/0165190 A1
(43) Pub. Date: Jul. 10, 2008

(54) APPARATUS AND METHOD OF DISPLAYING OVERLAID IMAGE

(75) Inventors: SUNG-HWAN MIN, Seoul (KR); Sung-hee Cho, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/851,717

(22) Filed: Sep. 7, 2007

(30) Foreign Application Priority Data
Jan. 9, 2007 (KR) 2007-2590

(51) Int. Cl. G06T 15/40

(52) U.S. Cl. 345/421

(57) ABSTRACT

An apparatus to display an overlaid image includes an alpha-value-checking unit to check a 3D object having an alpha value among 3D objects of an overlay plane, a blending unit to blend the 3D object and the previously painted overlay plane based on a plurality of blending rules if the 3D object has a predetermined alpha value as a result of the check by the alpha-value-checking unit, and a rendering unit to render the blended 3D object and the previously painted overlay plane.

### CROSS-REFERENCE TO RELATED APPLICATION

This application claims the benefit of Korean Application No. 2007-2590, filed Jan. 9, 2007, in the Korean Intellectual Property Office, the disclosure of which is incorporated herein by reference.

### BACKGROUND OF THE INVENTION

1. Field of the Invention

Aspects of the present invention relate to an apparatus to synthesize a video and an overlay, and more particularly to a method and apparatus to display an overlaid image.

2. Description of the Related Art

Generally, a digital television (TV) is an apparatus to receive a digital broadcast via a tuner and to display the digital broadcast on a screen. A method that may be associated with the digital broadcast includes extracting information of an image from digital broadcast data received via the tuner, decoding MPEG-2 data of the digital broadcast data, and outputting the image. Here, a decoded video image is on a video plane. Also, an application, such as a TV menu or an electronic program guide (EPG), is output in a separate area (overlay plane). This overlay plane exists at an upper portion than that of the video plane, which makes the menu to appear above the video.

Applying a result painted by a 3D graphics pipeline to the overlay plane might cause a problem due to an alpha value of a miscalculated overlay plane. That is, an incorrect alpha value mixes an opaque menu or the EPG screen output with the decoded video image. Therefore, the portions of the EPG or the menu application appear transparent.

In order to apply a 3D-based graphical user interface (GUI) to an embedded system, such as the digital TV, a result rendered by the 3D graphics pipeline should be painted (or applied) on (or over) the overlay plane. API (application programming interface) specifications of the 3D graphics pipeline include open GL, Direct X, and Open GL ES. Particularly, Open GL ES 1.0 was selected as a standard for use in the embedded system. Here, the Open GL is an abbreviation of open graphics library, and refers to an API distributed by Silicon Graphics for real-time rendering.

A process of painting an object of a single frame by using a related art 3D graphics pipeline based on Open GL ES 1.0 API (open graphics library embedded systems 1.0 application program interface) will be described in the following. First, an opaque 3D object is rendered without being synthesized, and a semitransparent 3D object is synthesized with a previously painted overlay plane through the following blending rule.

r=s*sA+d*(1−sA)

Here, s (source) refers to a 3D object (such as the semitransparent 3D object) to be painted on the previously painted overlay plane, sA (source α) refers to an alpha (α) value of the 3D object (such as the semitransparent 3D object) to be painted on the previously painted overlay plane, d (destination) refers to a 3D object (such as the opaque 3D object) that was already painted on the previously painted overlay plane, and r (result) refers to a blended result value.

The blending rule is useful for synthesizing a color value of the 3D object (or objects), but is not proper for synthesizing the alpha value (α) because the alpha value (α) is calculated using value rA=sA*sA+dA*(1−sA), and because the alpha value (α) could be lower than that of the 3D object to be displayed after the synthesis. For example, if the semitransparent 3D object is painted on the opaque 3D object, the alpha value (α) decreases to less than 1.0 by way of the blending rule. Therefore, the video located at the bottom of the screen of the embedded system is synthesized with the semitransparent 3D object, and is output. Therefore, if the semitransparent 3D object exists (or is rendered) on the opaque 3D object, the video of the semitransparent 3D at the bottom would be invisible. This problem should be avoided and needs to be solved.

Korean Unexamined Patent Publication No. 2001-029212 discloses a method of rendering a 3D object programmed by an Open GL interface, including a first operation of making a program to render a 3D object by using the Open GL interface, a second operation of performing a pre-process to render the 3D object, a third operation of converting the Open GL program by applying the Open GL program to a rendering library so that a renderer can render the 3D object, and a fourth operation of rendering the 3D object by driving the converted program. However, a technology of preventing output of the video synthesized with the semitransparent 3D object is not mentioned therein.

### SUMMARY OF THE INVENTION

An object of the present invention is to provide a method and apparatus to synthesize a video and an overlay naturally based on an Open GL ES (open graphics library embedded systems) specification, such as the Open GL ES 1.0 specification.

According to an aspect of the present invention, an apparatus to display an overlaid image includes an alpha-value-checking unit to check a 3D object having an alpha value among 3D objects of a previously painted overlay plane, a blending unit to blend the 3D object the previously painted overlay plane based on a plurality of blending rules, if the 3D object has a predetermined alpha value as a result of the check by the alpha-value-checking unit, and a rendering unit to render the blended 3D object and the previously painted overlay plane.

According to an aspect of the present invention, a method of displaying an overlaid image includes checking a 3D object having an alpha value among 3D objects of a previously painted overlay plane, blending the 3D object having the alpha value and the previously painted overlay based on a plurality of blending rules if the 3D object has a predetermined alpha value as a result of the checking, and rendering the overlay plane of the 3D object blended through the plurality of blending rules.

According to an aspect of the present invention, a method of displaying an overlaid image includes obtaining an alpha value of an object to be blended with an overlay plane, a first blending process to blend the object with the overlay plane using a first blending rule and obtaining a first result having a range of alpha values that decreased, a second blending process to blend a polygon with the first result using a second blending rule to obtain a second result to increase the range of the alpha values, and rendering the second result.

According to an aspect of the present invention, an apparatus to display an overlaid image includes an alpha-value-checker to obtain an alpha value of an object to be blended with an overlay plane, a blender to perform a first blending process to blend the object with the overlay plane using a first blending rule and obtaining a first result having a range of alpha values that decreased, and a second blending process to blend a polygon with the first result using a second blending rule to obtain a second result to increase the range of the alpha values, and a renderer to rendering the second result.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 illustrates a block diagram of an apparatus to display an overlaid image according to an aspect of the present invention;

FIG. 2 illustrates a method of displaying an overlaid image according to an aspect of the present invention; and

FIG. 3A illustrates a screen where a blending process is performed once on a 3D object as in a related art, and FIG. 3B illustrates a screen where a blending process is performed twice on a 3D object, in a device that displays an overlaid image according to an aspect of the present invention.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

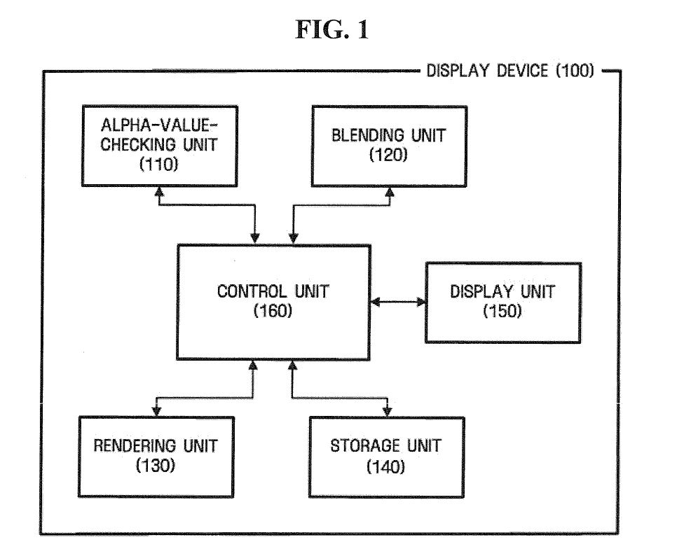

FIG. 1 illustrates a block diagram of an apparatus to display an overlaid image according to an aspect of the present invention. As shown, the synthesis of a 3D object (or objects) of an overlay plane will be described based on an Open GL ES 1.0 API (open graphics library embedded systems 1.0 application programming interface). Also, the 3D object of the overlay plane is divided into an opaque 3D object and a semitransparent 3D object, and the rendering thereof can be immediately performed on the opaque 3D object without a blending process. Here, the blending refers to a visual technique for combining two textures and displaying the blend on the same object. In other aspects of the present invention, any Open GL ES API is within the scope of the aspects of the present invention, such as Open GL ES 1.5, 2.0, or others.

As illustrated, a display device 100 includes an alpha-value-checking unit 110, a blending unit 120, a rendering unit 130, a storage unit 140, a display unit 150, and a control unit 160. The display device 100 is an embedded device, such as, a digital TV and/or a DVD for playing (or displaying) an image. The alpha-value-checking unit 110 checks a 3D object having an alpha value among 3D objects of an overlay plane. As shown, checking the 3D object having the alpha value is performed so as to blend the 3D object having the alpha value and a previously painted overlay plane. That is, a 3D object having no alpha value does not perform (or participate in) the blending process. In various aspects, alpha value refers to opacity. Accordingly, an alpha value of 0 refers to complete transparency, while an alpha value of 1.0 refers to complete opacity.

The blending unit 120 blends the 3D object having the alpha value and the previously painted overlay plane. The blending-performing unit 120 blends the previously painted overlay plane and the 3D object through two blending rules. The two blending rules are provided by the Open GL ES 1.0 specification, and the first blending rule is:

r₁=s*sA+d*(1−sA),

where, s (source) refers to the 3D object to be painted (or blended) on the previously painted overlay plane, sA (source α) refers to an alpha (α) value of the 3D object to be painted on the overlay plane, d (destination) refers to a 3D object that is already painted on the previously painted overlay plane, and r₁ (result) refers to a first blended result value. The second blending rule is:

r₂=s*dA+d*(1),

where, the s (source) refers to the 3D object to be painted (or blended) on the previously painted overlay plane, dA (destination α) refers to an alpha (α) value of the 3D object that is already painted on the previously painted overlay plane, d (destination) refers to the 3D object that is already painted on the previously painted overlay plane, and r₂ (result) refers to a second blended result value. In various aspects, the 3D object of the previously painted overlay plane may be opaque. In various aspects, the overlay plane need not have been previously painted with a 3D object.

First, the opaque 3D object having the alpha value and the previously painted overlay plane are blended through the first blending rule. When the blending is performed through the first blending rule, the alpha values that range from 0 to 0.25 decrease. Also, the first blending rule is a rule commonly used for the blending operation. In other aspects, other alpha value ranges are within the scope of the present invention.

The blending is performed again using the second blending rule to cover (or for) a single polygon whose color value is 0 and an alpha value is 0.5 on the first blended area. That is, after blending is performed through the first blending rule, the single polygon, having a color value of 0 and an alpha value of 0.5, is painted once more based on the second blending rule in order to correct the alpha value of the 3D object having an alpha value in the range from 0.7 to less than 1.0. By performing the blending through the second blending rule, the color does not change and only the decreased alpha value are increased, to thereby produce an alpha value that is greater than 1.0. However, the alpha value that exceeds 1.0 is processed (or set) as 1.0 during the second blending, and the single polygon is located in an area where an entire screen or an overlay plane is blended through the second blending rule. In other aspects, other selective color, alpha values, and/or alpha ranges are within the scope of the present invention. In various aspects, the destination d may be a background having a certain texture and/or color and the source s may be a 3D object to be rendered or painted on the background.

For natural synthesis of an alpha plane and a video plane, the color should be selected according to the first blending rule and the alpha value should be selected according to: rA=sA*dA+d*(1−sA). However, a related art hardware of the Open GL ES 1.0 specification does not provide a blending rule therefore. Accordingly, a decreased alpha value exists once the first blending process is performed. Accordingly, the decreased alpha value can be increased once the first blending process is performed by using the second blending rule of the Open GL ES 1.0 specification. When the polygon is further painted (or rendered) based on the second blending rule, a stencil buffer can be used for more accuracy.

The rendering unit 130 renders the overlay plane of the 3D object blended through the blending-performing unit 120. The rendering unit 130 renders the opaque 3D object, and also renders the blended 3D object. The storage unit 140 stores information of the video plane, the overlay plane, and the 3D object. The stored information refers to the alpha value (α) of a predetermined object (such as the 3D object) and the blending rule or rules.

The display unit 150 displays the video plane and the overlay plane. The video plane or the synthesis of the video plane and the overlay plane can be displayed on the display device 100. The control unit 160 controls the operations of each functional block 110 to 150 included in the display device 100.

Meanwhile, the term “unit”, used herein, refers to, but is not limited to, a software or hardware component, such as a Field Programmable Gate Array (FPGA) or an Application Specific Integrated Circuit (ASIC), which performs certain tasks. A “unit” may advantageously be configured to reside in the addressable storage medium, and to execute on one or more processors. Thus, a “unit” may include, by way of example, components, such as software components, object-oriented software components, class components and task components, process, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and modules.

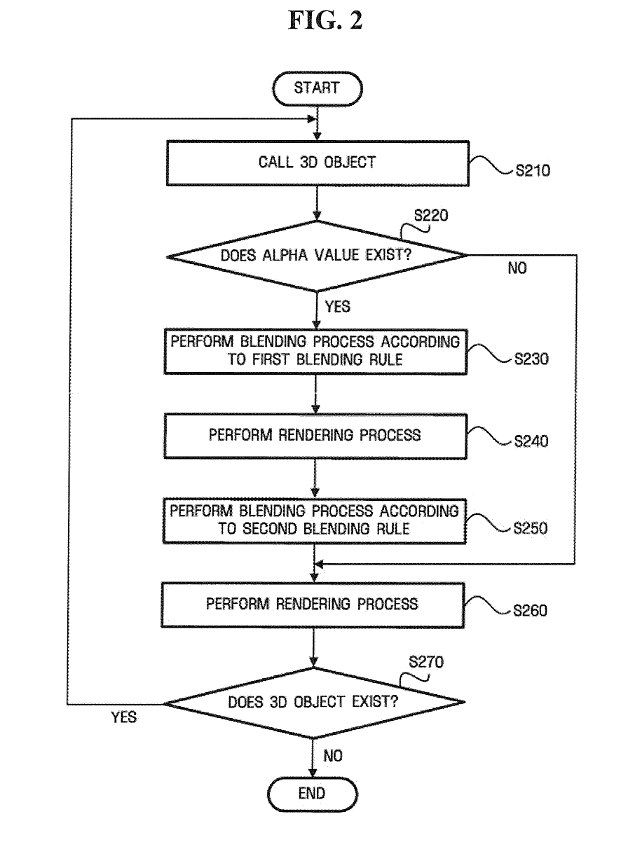

FIG. 2 illustrates a method of displaying an overlaid image according to an aspect of the present invention. First, the storage unit 140 calls (or obtains) a 3D object of an overlay plane (operation S210). Then, the alpha-value-checking unit 110 checks whether the 3D object has an alpha value (or determines the alpha value). In the aspect shown, checking of the 3D object having the alpha value is performed in order to blend the 3D object having the checked alpha value and the previously painted overlay plane.

If the alpha value does not exist as a result of the checking (operation S220), the rendering-performing unit 130 renders the previously painted overlay plane having a 3D object (operation S260). If the alpha value exists as a result of the checking (operation S220), the blending-performing unit (or the blending unit) 120 blends the 3D object having the alpha value and the previously painted overlay plane through the first blending rule (operation S230). In this aspect, when the blending is performed through the first blending rule, the alpha values that range from about 0 to 0.25 decrease. The first blending rule was described with reference to the blending unit 120, and therefore, a detailed description will not be repeated.

Next, the rendering-performing unit (or the rendering unit) 130 renders the previously painted overlay plane with the blended 3D object (operation S240). The 3D object having alpha values from 0.75 to less than 1.0 is obtained after the first blending process is performed by the blending-performing unit 120 according to the first blending rule. However, in order to correct the alpha value, a second blending process is performed according to the second blending rule by covering the blended area with a single polygon where the color value is 0 and the alpha value is 0.5 (operation S250). Therefore, the color does not change, and only the decreased alpha value is increased to more than 1.0. In this aspect, the value that exceeds 1.0 during the blending process is processed as 1.0.

Next, the rendering unit 130 renders the overlay plane of the blended 3D object (operation S260). Next, the control unit 160 checks if another 3D object exists for blending (operation S270), and if the another 3D object does not exist, ends the image-overlaying process.

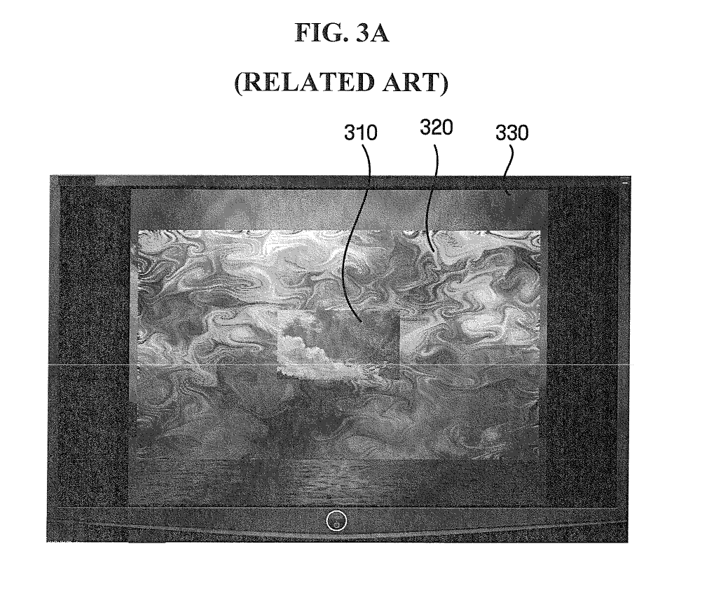

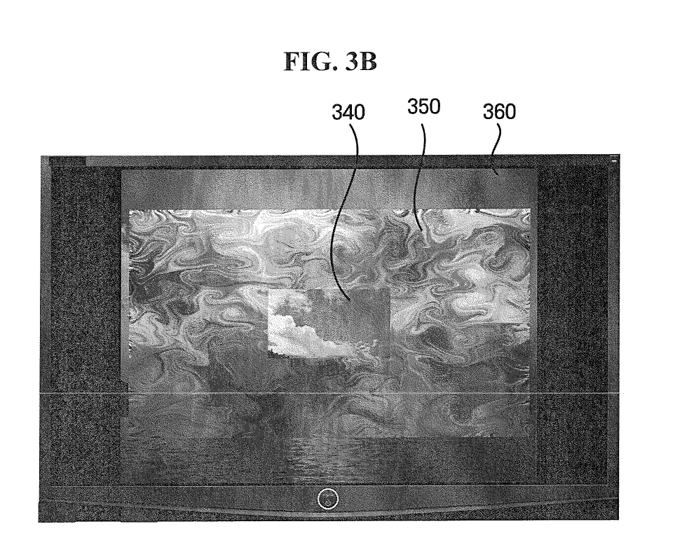

FIG. 3A illustrates a screen where a blending process is performed once on a 3D object as in a related art, and FIG. 3B illustrates a screen where the blending process is performed twice on the 3D object, in a device that displays the overlaid image according to an aspect of the present invention. As shown, FIG. 3A shows a screen where only the first blending rule is performed, and FIG. 3B shows a screen where the first and the second blending rules are performed.

As illustrated in FIG. 3A, the video plane and the overlay plane are synthesized on the display device 100. That is, since the 3D objects are blended only thorough the first blending rule, a color of a video 330, such as red, is displayed on (or bleeds through) a semitransparent 3D object 310 located on the opaque 3D object 320.

As illustrated in FIG. 3B, the video plane and the overlay plane are synthesized on the display device 100. That is, since the 3D objects are blended through the first and second blending rules, the color of the video 360 is not displayed on the semitransparent 3D object 340. Therefore, the semitransparent object 340 does not receive (or display) a color of an image of the video 360 (such as a background) and the original color of the semitransparent object 350 is displayed.

As described above, the method and apparatus to display an overlaid image produce one or more of the following effects. A user can be provided with an application including a graphical user interface (GUI) even in hardware using the Open GL ES 1.0 standard without any additional cost by naturally correcting the synthesis of a video and a 3D overlay.

In various aspects, the hardware refers to a television, a digital versatile disc (DVD) player, embedded devices, or other electronic devices.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. An apparatus to display an overlaid image, the apparatus comprising:
an alpha-value-checking unit to check a 3D object having an alpha value among 3D objects of a previously painted overlay plane;
a blending unit to blend the 3D object and the previously painted overlay plane based on a plurality of blending rules, if the 3D object has a predetermined alpha value as a result of the check by the alpha-value-checking unit; and
a rendering unit to render the blended 3D object and the previously painted overlay plane.

2. The apparatus of claim 1, wherein a first of the blending rules is indicated by r₁=s*sA+d*(1−sA),
where, s (source) refers to the 3D, sA (source α) refers to an alpha (α) value of the 3D object, d (destination) refers to a 3D object that is already painted on the previously painted overlay plane, and r₁ (result) refers to a first blended result value, and
a second of the blending rules is indicated by: r₂=s*dA+d*(1),
where s (source) refers to the 3D object, dA (destination α) refers to the alpha (α) value of the 3D object that is already painted on the previously painted overlay plane, and d (destination) refers to the 3D object that is already painted on the previously painted overlay plane.

3. The apparatus of claim 2, wherein blending is performed by the blending unit according to the second blending rule where a color value is 0 and the destination alpha value is 0.5.

4. The apparatus of claim 1, wherein an open GL ES (graphics library embedded system) 1.0 specification is used by the apparatus.

5. A method of displaying an overlaid image, the method comprising:
checking a 3D object having an alpha value among 3D objects of a previously painted overlay plane;
blending the 3D object having the alpha value and the previously painted overlay plane based on a plurality of blending rules if the 3D object has a predetermined alpha value as a result of the checking; and
rendering the overlay plane of the 3D object blended through the plurality of blending rules.

6. The method of claim 5, wherein a first of the blending rules is indicated by r₁=s*sA+d*(1−sA),
where, s (source) refers to the 3D, sA (source α) refers to an alpha (α) value of the 3D object, d (destination) refers to a 3D object that is already painted on the previously painted overlay plane, and r₁ (result) refers to a first blended result value, and
a second of the blending rules is indicated by r₂=s*dA+d*(1),
where s (source) refers to the 3D object, dA (destination α) refers to the alpha (α) value of the 3D object that is already painted on the previously painted overlay plane, and d (destination) refers to the 3D object that is already painted on the previously painted overlay plane.

7. The method of claim 6, wherein blending of the 3D object is performed according to the second blending rule where a color value is 0 and the destination alpha value is 0.5.

8. The method of claim 5, wherein the blending of the 3D object is based on an Open GL ES (graphics library embedded system) 1.0 specification.

9. A method of displaying an overlaid image, comprising:
obtaining an alpha value of an object to be blended with an overlay plane;
a first blending process to blend the object with the overlay plane using a first blending rule and obtaining a first result having a range of alpha values that decreased;
a second blending process to blend a polygon with the first result using a second blending rule to obtain a second result to increase the range of the alpha values; and
rendering the second result.

10. The method of claim 9, wherein the first blending process is performed according to the first blending rule of r₁=s*sA+d*(1−sA),
where, s (source) refers to the object, sA (source α) refers to an alpha value of the object, d (destination) refers to the overlay plane, and r₁ (result) refers to a first blended result.

11. The method of claim 10, wherein the second blending process is performed according to the second blending rule of r₂=s*dA+d*(1),
where, the s (source) refers to the object, dA (destination α) refers to an alpha value of the overlay plane after the first blending, d (destination) refers to the overlay plane after the first blending, and r₂ (result) refers to a second blended result.

12. The method of claim 9, wherein the range of alpha values that decreased are about 0 to 0.25.

13. The method of claim 9, wherein the polygon has a color value of 0 and an alpha value of 0.5.

14. The method of claim 9, wherein an alpha value that exceeds 1.0 is set to be 1.0.

15. An apparatus to display an overlaid image, comprising:
an alpha-value-checker to obtain an alpha value of an object to be blended with an overlay plane;
a blender to perform a first blending process to blend the object with the overlay plane using a first blending rule and obtaining a first result having a range of alpha values that decreased, and a second blending process to blend a polygon with the first result using a second blending rule to obtain a second result to increase the range of the alpha values; and
a renderer to rendering the second result.

16. The apparatus of claim 15, wherein the first blending process is performed according to the first blending rule of r₁=s*sA+d*(1−sA),
where, s (source) refers to the object, sA (source α) refers to an alpha value of the object, d (destination) refers to the overlay plane, and r₁ (result) refers to a first blended result.

17. The apparatus of claim 15, wherein the second blending process is performed according to the second blending rule of r₂=s*dA+d*(1),
where, the s (source) refers to the object, dA (destination α) refers to an alpha value of the overlay plane after the first blending, d (destination) refers to the overlay plane after the first blending, and r₂ (result) refers to a second blended result.

18. The apparatus of claim 15, wherein the range of alpha values that decreased are about 0 to 0.25.

19. The apparatus of claim 15, wherein the polygon has a color value of 0 and an alpha value of 0.5.

20. The method of claim 15, wherein an alpha value that exceeds 1.0 is set to be 1.0.
